(19) United States
(12) Patent Application Publication
(10) Pub. No.: US 2006/0007568 A1
(43) Pub. Date: Jan. 12, 2006

(54) Optical scanning device

(76) Inventors: Bernardus Hendrikus Wilhelmus Hendriks, Eindhoven (NL); Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/532,901

(22) PCT Filed: Oct. 20, 2003
(86) PCT No.: PCT/IB03/04629

§ 371 Date: Apr. 27, 2005

(30) Foreign Application Priority Data
Nov. 1, 2002 (EP) 02079589.4

(51) Int. Cl. G02B 5/04

(52) U.S. Cl. 359/834

(57) ABSTRACT

An optical scanning device including an optical element (12) having at least two portions, including a body portion (14) having relatively low birefringence and a wavefront aberration generating portion (16) having a relatively high birefringence, the body portion having an attachment surface on which the wavefront aberration generating portion is formed. The wavefront aberration generating portion (16) has a first surface facing the body portion and a second surface facing away from the body portion, the first and second surfaces being of a different shape so that the thickness of the wavefront aberration generating portion, measured parallel to the optical axis, varies along a direction perpendicular to the optical axis. The thickness of the wavefront aberration generating portion at the optical axis is less than half the thickness of the body portion at said optical axis.

This invention relates to an optical scanning device for scanning an optical record carrier, such as an optical disk, including at least one information layer. The invention also relates to an optical element for use in such a scanning device.

Optical pickup units for use in optical scanning devices are known. The optical pickup units may be mounted on a movable support for radially scanning across the tracks of the optical disk. The size and complexity of the optical pickup unit is preferably reduced as much as practicable, in order to reduce the manufacturing cost and to allow additional space for other components to be mounted in the scanning device.

Modern optical pickup units are generally compatible with at least two different formats of optical disk, such as the Compact Disk (CD) format and the Digital Versatile Disk (DVD) format. Whilst it is possible to provide an optical pickup unit which has an optical system that allows scanning of both CD and DVD disks in an infinite conjugate arrangement. However, that arrangement tends to give rise to a relatively large amount of spherical aberration when scanning one of the different-format disks. This arises due to the difference in information layer depth in the two formats.

One known arrangement used to provide spherical aberration compensation involves the use of an aspherical objective lens with a diffractive structure formed on the lens. A drawback of this arrangement is the loss of radiation intensity caused by the diffractive structure.

Another known arrangement involves arranging the optical system such that for scanning a CD-format disk (CD mode) a finite conjugate arrangement is used. This means that the CD scanning beam incident on optical elements in the system, including the objective lens, is a non-collimated beam, whilst the objective lens is designed to operate with a collimated beam in the DVD mode. A drawback of this arrangement is that the tolerances for use of the field of the objective lens, decentring of the objective lens and thickness variations in the disks, become so small as to make an optical scanning device significantly more difficult to manufacture reliably.

U.S. Pat. No. 5,876,315 describes a bifocal crystal optic lens made of two portions joined at a curved lensing surface, for scanning disks having information layers arranged at different depths. At least one of the portions is birefringent to compensate for the different amounts of spherical aberration generated by the disk cover layers. However, using such an additional component adds to manufacturing cost and, furthermore, a substantial amount of astigmatism is generated by the birefringent portion or portions.

In accordance with one aspect of the invention, there is provided an optical scanning device for scanning optical record carriers, the device comprising an optical system for converging first and second radiation beams onto the optical record carriers being scanned, the optical system including an optical element arranged along an optical axis and having at least two portions, including a body portion having relatively low birefringence and a wavefront aberration generating portion having a relatively high birefringence, the body portion having an attachment surface on which the wavefront aberration generating portion is formed, the wavefront aberration generating portion having a first surface facing said attachment surface and a second surface facing away from said attachment surface, the first and second surfaces being of a different shape so that the thickness of the wavefront aberration generating portion, measured parallel to said optical axis, varies along a direction perpendicular to the optical axis, and wherein the thickness of the wavefront aberration generating portion at said optical axis is less than half the thickness of the body portion at said optical axis.

By means of the present invention, different desired wavefront aberrations may be generated in different operating modes of the optical element when scanning the different information layers, whilst reducing the amount of birefringent material used in the element. The body portion of the lens has a relatively low birefringence, compared to the birefringence of the wavefront aberration generating portion, which is arranged to have a relatively small thickness. Therefore, unwanted effects caused by birefringence, such as astigmatism, can be reduced.

The body portion has a relatively low birefringence. Preferably, the material of which the body portion is made is selected such that the magnitude of a difference Δn_{(LOW)} between a refractive index no for ordinary radiation and a refractive index nₑ for extra-ordinary radiation is less than 0.03, more preferably less than 0.01.

The wavefront aberration generating portion has a relatively high birefringence. Preferably, the material of which the wavefront aberration generating portion is made is selected such that the magnitude of a difference Δn_{(HIGH)} between a refractive index nₒ for ordinary radiation and a refractive index ic for extra-ordinary radiation is more than 0.03, more preferably more than 0.05.

Preferably, the body portion is made of a non-birefringent material. More preferably, the body portion is made of a glass material. Glass materials are generally stable with respect to environmental variations, for example in temperature and humidity. Furthermore, glass materials provide a relatively wide variation in choice of refractive index and dispersion, allowing greater design freedom.

The wavefront aberration generating portion is preferably arranged to generate a difference in the amount of wavefront aberration, which is greater than the difference in the amount of wavefront aberration generated by the body portion, when scanning with the two different radiation beams respectively. The invention may be used for example for compensating spherical aberration. A first amount of spherical aberration can be generated by the wavefront aberration generating portion when scanning an information layer at a first depth, and a second amount of spherical aberration can be generated by the wavefront aberration generating portion when scanning an information layer at a second depth. Meanwhile, with the body portion in the form of a lens body and arranged as an objective lens, the main focusing power of the lens can be provided by the lens body.

Preferably, the curved surface of the lens body is substantially spherical. Such a spherical surface is relatively inexpensive to manufacture, in particular in a glass lens body. A plano-spherical lens body is particularly inexpensive to manufacture.

In one embodiment of the invention, an optical scanning device is provided having two different infinite conjugate optical path arrangements. One of two information layers, at a first information layer depth, is scanned in a first mode by means of a radiation beam having a predetermined polarization and the other information layer, at a second, different information layer depth is scanned in the second mode by means of another radiation beam having a different polarization. Thus, while the different amounts of spherical aberration are generated due to the difference in information layer depths between the two layers, the lens accordingly compensates such spherical aberration in each case by introducing a different wavefront modification in each mode. Thereby, a system having good degrees of tolerance for field and thickness variations can be produced.

The invention also relates to an optical element for use in a scanning devices and showing the features described herein above.

Further features and advantages of the invention will become apparent from the following description of preferred embodiments of the invention. Embodiments of the invention will now be described, by way of example only, with reference to the following drawings, wherein:

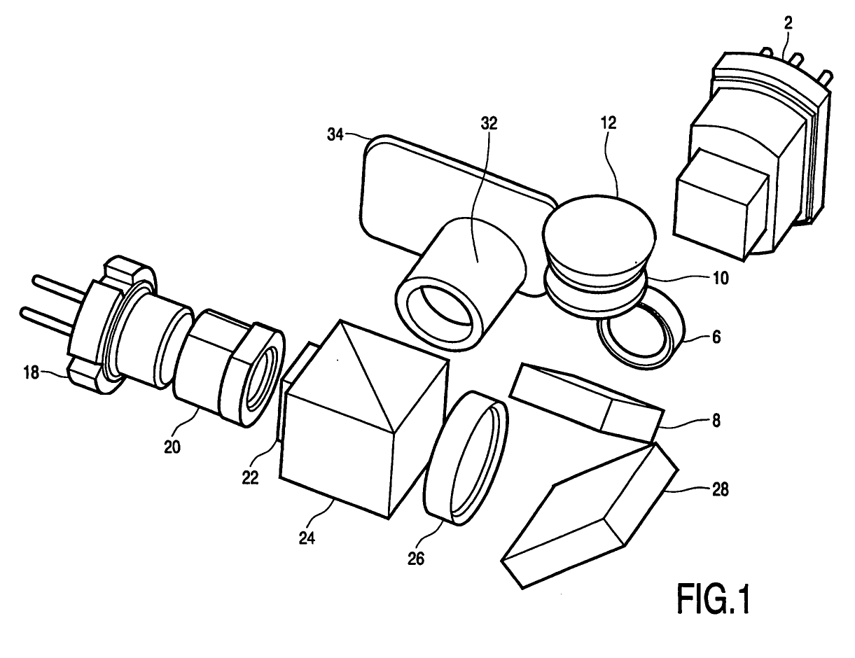

FIG. 1 is a perspective view of elements of an optical scanning device in accordance with a first embodiment of the invention;

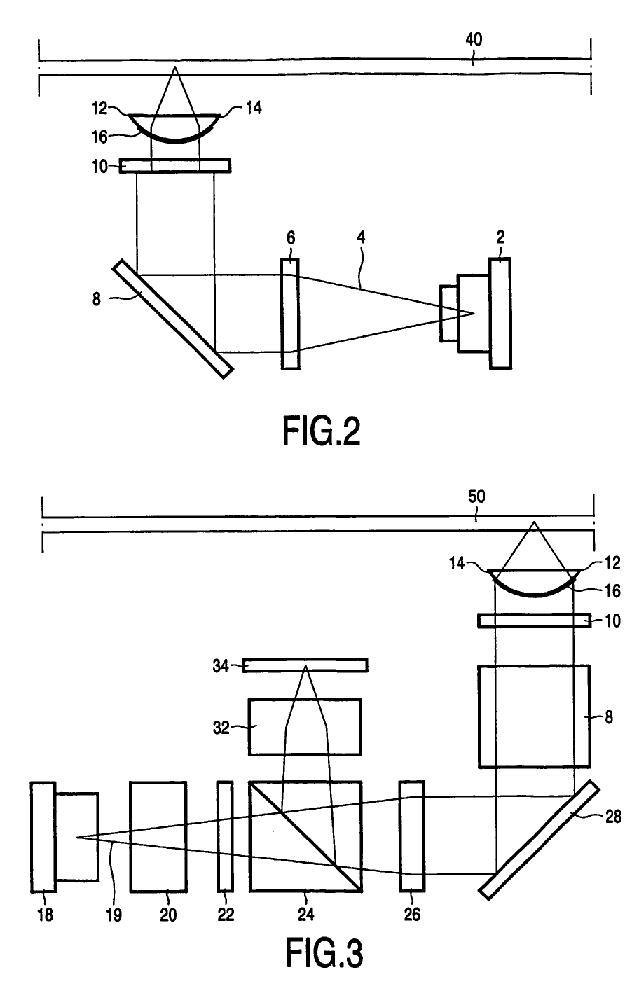

FIG. 2 is a schematic side view of one branch of the optical scanning device shown in FIG. 1;

FIG. 3 is a schematic side view of another branch of the optical scanning device shown in FIG. 1;

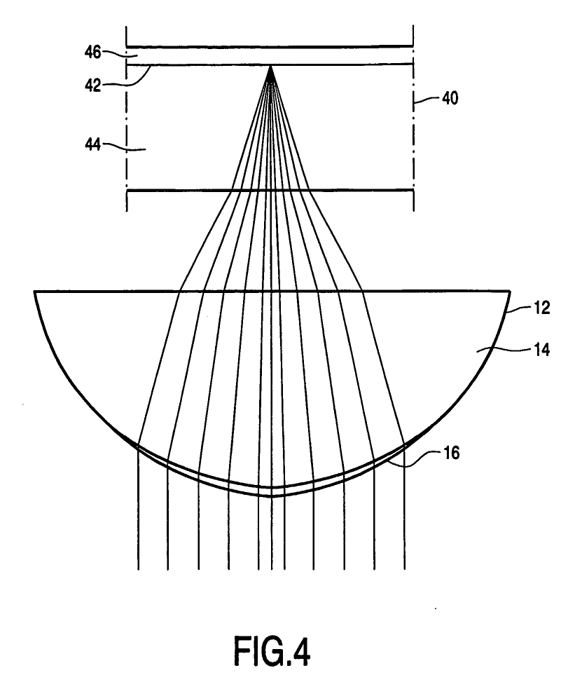

FIG. 4 is a cross-sectional side view of an objective lens in accordance with an embodiment of the invention and a ray trace plot when scanning a first format of optical record carrier; and

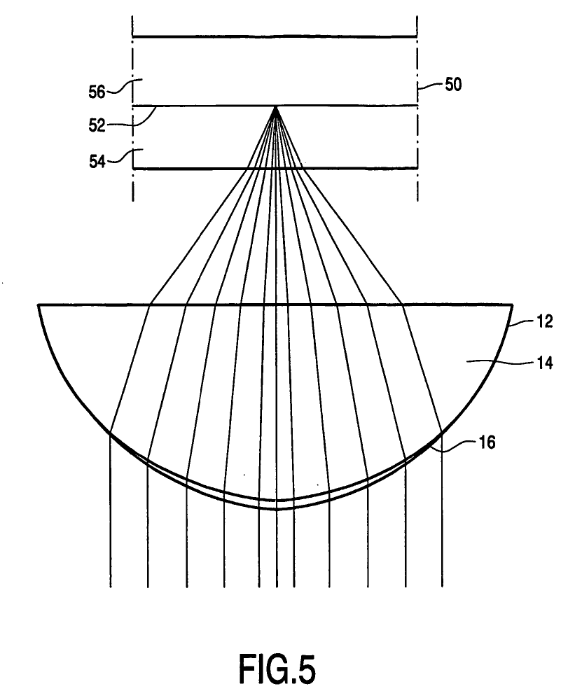

FIG. 5 is a cross-sectional side view of this objective lens and a ray trace plot when scanning a second format of optical record carrier.

In accordance with embodiments of the invention, different formats of optical recording medium including read-only optical disks, such as CD (Compact Disk), and DVD (Digital Versatile Disk); and recordable optical disks, such as a CD-R (Compact Disk−Recordable), CD-RW (Compact Disk−Rewritable) and DVD+RW (Digital Versatile Disk+Rewritable) may be written and/or read-out by means of an optical pickup unit (OPU) mounted in an optical disk playback and/or recording device. The optical components of the OPU are held in a rigid housing which is formed of moulded aluminium or suchlike. The OPU may be arranged in a movable support such that the OPU travels radially of the disk during scanning of the disk. Each disk to be scanned is located in a planar scanning area adjacent to the OPU, mounted on a motorised rotating bearing in the playback and/or recording device, whereby the disk is spun relative to the OPU during playback and/or writing.

Each of the different formats of disk to be scanned by the device includes at least one information layer. Information may be stored in the information layer or layers of the optical disk in the form of optically detectable marks arranged in substantially parallel, concentric or spiral tracks. The marks may be in any optically readable form, for example in the form of pits or areas with a reflection coefficient different from their surroundings. In the case of recordable disks, the information layer or layers are formed of an optically recordable material, for example a radiation-sensitive dye as used in the CD-R format, or a phase change material as used in the DVD+RW format, which requires a relatively high power for rewriting the disk, compared to that required for data read-out.

The OPU includes two optical branches for scanning disks with radiation of two different wavelengths, in this embodiment a wavelength of approximately 780 nm (referred to herein as “the first wavelength”) and a wavelength of approximately 650 nm (referred to herein as “the second wavelength”). It should however be appreciated that optical scanning devices in accordance with different embodiments of the invention may operate at other wavelengths, and with more than two wavelengths.

Reference is now made to FIGS. 1 and 2. The first optical branch, which is arranged in a planar layer parallel to the optical disk scanning area, in this embodiment comprises a Laser Detector Grating Unit (LDGU) 2 which includes a polarised radiation source, for example a semiconductor laser, operating at a predetermined wavelength, in this example the first wavelength, to produce a first beam 4; a photodiode detector array for detecting a data signal and focus and radial tracking error signals in the first beam reflected from the optical disk; and a holographic grating for splitting the beam for the focus and radial tracking error signal generation. The LDGU 2 emits a diverging radiation beam 4. The first branch further includes, arranged along a first linear optical path portion along with the LDGU, a collimator lens 6 for converting the divergent beam in a collimated beam and a dichroic beam splitter 8. This beam splitter folds the first beam through 90° to be directed towards a first format of optical disk 40 along the axial direction of the disk 40, in this embodiment a CD-type format of disk. The first optical disk 40 is one designed for readout and/or writing at the first wavelength.

In the optical path portion between the beam splitter 8 and the first optical disk 40, which portion is shared by the two radiation beams of the device, lies a dichroic aperture 10, operative to reflect radiation at the first wavelength in an area outside a predetermined radial distance from the optical axis, and a dual beam objective lens 12. The dual beam objective lens 12, to be described in further detail below, has a lens body 14, which in this embodiment is plano-spherical, and a thin birefringent layer 16, which in this embodiment is spherical-aspherical. The objective lens 12 is arranged for correctly focusing, with a wavefront differently shaped for spherical aberration compensation in each case, the collimated first beam to a spot on the information layer in the disk operative at the first wavelength, and a collimated second beam to a spot on an information layer in a disk operative at the second wavelength.

The first beam is stopped by aperture 10 and focused by objective lens 12 to a spot on the first disk 40. The reflected beam is transmitted along the same path back to the LDGU 2, where the data, focus error and tracking error signals are detected. The objective lens 12 is driven by servo signals derived from the focus error signal to maintain the focussed state of the spot on the optical disk 40.

Reference is now made to FIGS. 1 and 3. The second optical branch is arranged in a single planar layer parallel to the optical disk scanning area in this embodiment. This branch includes a polarised radiation source 18, for example a semiconductor laser, operating at a predetermined wavelength different to that of the first beam, in this example the second wavelength, to produce a second beam 19. The first and second beams are substantially orthogonally polarised. The second optical branch includes, arranged along a second linear optical path portion along with the source 18, a beam shaper 20 for correcting ellipticity in the emitted beam and a grating 22 for splitting the second beam in a main beam and two tracking beams. The second optical branch further includes a beam splitter 24 for reflecting the reflected second beam towards a detector array 34, a collimator lens 26 for substantially collimating the second beam, and a folding mirror 28. This mirror reflects the second beam through 90° towards a second format of optical disk 50 along the axial direction of this disk, in this embodiment a DVD-type format of disk. The second optical disk 50 is a disk designed to operate at the second wavelength.

The second beam is transmitted substantially fully by the dichroic mirror 8, is transmitted by aperture 10 and focused to a spot on an information layer in the second optical disk 50. The reflected beam follows the same path back to beam splitter 24 and is reflected along a third linear optical path portion towards detector lens 32. This lens focuses the reflected beam on a photodiode detector array arranged on detector substrate 34, at which data, tracking error and focus error signals are detected. The objective lens 12 is driven by a mechanical actuator controlled by servo signals derived from the focus error signal to maintain the focussed state of the spot on the optical disk 12 and the detector array.

In the arrangement shown, both the first and second branches operate in an infinite conjugate mode, with the first and second beams being in a collimated state when incident upon, and after reflection through, the objective lens 12.

Reference is now made to FIGS. 4 and 5. The first disk 40 has an information layer 42 located behind a relatively thick cover layer 44, and protected on its opposite face by a protective layer 46. The cover layer 44 of the first disk has a thickness of 1.2 mm and a refractive index of n=1.573 for the first wavelength. The second disk 50 has an information layer 52 located behind a relatively thin cover layer 54, and protected on its opposite face by a protective layer 56. The cover layer 54 of the second disk has a thickness of 0.6 mm and a refractive index of n=1.580 for the second wavelength. The free working distance (the distance between the rear surface of the objective lens 12 and the disk) in FIG. 4 is 0.984 mm and in FIG. 5 is 1.308 mm

The objective lens 12 in the embodiment shown in FIGS. 4 and 5 will now be described in further detail. The objective lens 12 has, during scanning of the first disk 40, a numerical aperture of 0.45 and an entrance pupil diameter of 2.6 mm and operates with the first beam. The objective lens 12 has, during scanning of the second disk 50, a numerical aperture of 0.6 and an entrance pupil diameter of 3.3 mm and operates with the second beam. The direction of polarisation of the first beam is arranged such that the ordinary refractive index of the birefringent layer 16 is selected, while the direction of polarisation of the second beam is arranged such that the extra-ordinary refractive index of the birefringent layer 16 is selected. The convex front surface of the lens body 14 is spherical with a radius of curvature of 2.32 mm. The rear surface of the objective lens, which faces the record carrier when in use, is planar. The lens body 14 has a thickness along the optical axis which is preferably more than 500 μm, more preferably more than 1 mm, and in this embodiment 1.873 mm. The thickness of the lens body 14 is less than the radius of curvature of the lens body 14.

The lens body 14 is in this embodiment made of a non-birefringent material, such as SFL56 Schott™ glass with refractive index n=1.776 for the first wavelength and n=1.777 for the second wavelength.

The objective lens 121 comprises a birefringent layer 16, which is made of UW curable liquid crystal material formed on and attached to the front surface of the glass body 14, referred to herein as an attachment surface of the lens body 14. The required shape of the front surface of the birefringent layer 16 may be obtained by a replication technique using a mould having the reverse of this shape on its inner side. The mould may be shaped, for example using diamond turning. The material of the birefringent layer 16 has an ordinary refractive index of n=1.500 for the first wavelength and an extra-ordinary refractive index of nₑ=1.570 for the second wavelength. The thickness of the birefringent layer 16, measured parallel to the optical axis, varies with distance from the optical axis, and its thickness at the optical axis is less than 500 μm, more preferably less than 100 μm, yet more preferably less than 50 μm, and in this embodiment is 24 μm. In any case, the thickness of the birefringent layer 16, at the optical axis, is less than half of, more preferably less than one fifth of, and yet more preferably less than one tenth of, the thickness of the lens body 14 at the optical axis.

The thickness of the birefringent layer 16 varies due to asphericity of the front surface of the birefringent layer 16. The thickness of the birefringent layer is no more than 500 μm across the entire width of the first and second beams, more preferably no more than 100 μm and yet more preferably less than 50 μm. The average thickness of the birefringent layer, taken across at least one of the first and second beams, is no more than 500 μm across the birefringent layer 16, more preferably no more than 100 μm and yet more preferably less than 50 μm. The birefringent layer is preferably arranged to be sufficiently thin, whilst providing a desired variation in thickness, such that the thickness in one part of the birefringent layer 16 is at least half, more preferably at least one quarter, that of the thickness in another part of the layer.

By use of the present invention, the amount of astigmatism produced in the extra-ordinary mode of operation of the objective lens 12 is kept relatively small.

The rotational symmetric aspherical shape of the front surface of the birefringent layer 16 is given by the equation:

$$z ( r ) = {\sum }_{i = 1}^{8} {B}_{2 i} {r}^{2 i}$$

where z is the position of the surface in the direction of the optical axis in millimetres, r the distance from the optical axis in millimetres, and Bₖ the coefficient of the k-th power of r. In this embodiment the value of the coefficients B₂ to B₁₆ are 0.2424264, 0.0043255068, 0.0009125206, −0.0014347554, 0.0010154642, −0.00042306993, 9.1869093×10⁻⁵ and −8.1502828×10⁻⁶, respectively.

Thus, it will be appreciated that a lens arranged in accordance with the present invention provides two distinct operating modes which may be used consecutively or simultaneously. In a first operating mode, the lens is used for scanning an information layer in a record carrier by means of a first radiation beam. The first radiation beam has one or more predetermined characteristics representative of the first mode, including its polarization. In a second operating mode, the lens is used for scanning an information layer in a record carrier by means of a second radiation beam. The second radiation beam has one or more predetermined characteristics representative of the second mode, including a different polarization. In other words, each operating mode may be characterized from another mode by means of at least one parameter having a first predetermined value for that mode and a second, different predetermined value for the other mode.

An optical scanning device according to the above embodiments of the invention is suitably arranged for scanning optical record carriers of at least two different formats in different operating modes, respectively. Alternatively, a scanning device may be suitably arranged for consecutively scanning different layers of a multilayer optical record layer in different operating modes of the lens. Further alternatively, a scanning device may be suitably arranged for scanning different layers of a multilayer optical record carrier simultaneously in different operating modes of the lens. In this case, the different layers may be scanned using two different sub-beams produced from a single main beam.

In another alternative arrangement for the optical scanning device described above, the polarization of a single radiation beam traversing the objective lens 12 is switched between a first state and a second state such that the lens generates a first wavefront aberration when that polarization is in the first state and a second, different wavefront aberration when that polarization is in the second state. It is noted that such switching of polarizations using a liquid crystal cell is known, for example from International Patent application number WO 01/24174.

Herein, the term “wavefront aberration generation” refers to a non-spherical modification of the shape of the wavefront of a radiation beam by an optical element. It can be quantified by taking the root mean square (RMS) value of the wavefront deviation from the closest approximating spherical wavefront, integrated over the entrance pupil of the optical element, before and after a radiation beam passes through the element, and taking the magnitude of the difference.

The wavefront aberration generated by the birefringent layer 16 may be rotationally symmetric or asymmetric, including one or more components of a first, second, etc. order of wavefront aberration. The term “rotationally symmetric” refers to a shape which is rotationally symmetric over an azimuthal angle of 2π with respect to the optical axis. For instance, a wavefront aberration generated to provide spherical aberration, as in the above-described embodiments, is a rotationally symmetric aberration.

Note, in relation to the above-described embodiments, that the front surface of the birefringent layer 16 need not be rotationally symmetric; for example other types of wavefront aberration than spherical aberration may be desired to be produced, which vary between different operating modes of the lens. Furthermore, the birefringent layer 16 may include a non-rotationally symmetric stepped phase structure, which is non-periodic, i.e. non-repeating, with respect to a direction perpendicular to the optical axis. Such a structure may be formed on the front surface of the birefringent layer in order to correct for the relatively small amount of astigmatism produced in the extra-ordinary mode of operation. Such a correcting structure is described in our earlier European Patent application number 020789970, our reference PHNLO20915, filed 27 Sep. 2002, the contents of which are incorporated herein by reference.

In the above embodiments, the objective lens system includes a single objective lens. However in alternative embodiments a compound objective lens system may be used.

In the above embodiments, the birefringent layer 16 is formed on an objective lens; in alternative embodiments, a birefringent layer according to the invention may be formed, to provide a similar function, on a different lens in the system, for example a dual-beam collimator lens. Furthermore, whilst in the above embodiments, the birefringent layer 16 is formed on the curved front surface of the lens body 14, in an alternative arrangement a birefringent layer, having a non-planar outer surface arranged to provide varying amounts of wavefront aberration generating power in different modes, may be formed on the planar rear surface of the lens body 14. Furthermore, a birefringent layer arranged in accordance with the invention may be formed on a body portion which is not a lens, for example a planar plate.

The above embodiments are to be understood as illustrative examples of the invention. Further embodiments of the invention are envisaged. It is to be understood that any feature described in relation to one embodiment may also be used in other of the embodiments. Furthermore, equivalents and modifications not described above may also be employed without departing from the scope of the invention, which is defined in the accompanying claims.

1. An optical scanning device for scanning optical record carriers, the device comprising an optical system for converging first and second radiation beams onto the optical record carriers being scanned, the optical system including an optical element arranged along an optical axis and having at least two portions, including a body portion having relatively low birefringence and a wavefront aberration generating portion having a relatively high birefringence, the body portion having an attachment surface on which the wavefront aberration generating portion is formed, the wavefront aberration generating portion having a first surface facing said attachment surface and a second surface facing away from said attachment surface, the first and second surfaces being of a different shape so that the thickness of the wavefront aberration generating portion, measured parallel to said optical axis, varies along a direction perpendicular to the optical axis, and wherein the thickness of the wavefront aberration generating portion at said optical axis is less than half the thickness of the body portion at said optical axis.

2. An optical scanning device according to claim 1, wherein the thickness of the wavefront aberration generating portion along said optical axis is less than one fifth of the thickness of the body portion along said optical axis.

3. An optical scanning device according to claim 1, wherein the wavefront aberration generating portion is arranged to generate a difference in wavefront aberrations in said first and second beams respectively, which difference is greater than that generated by the body portion when illuminated by the first and second beams respectively.

4. An optical scanning device according to claim 1, wherein the body portion is a lens body.

5. An optical scanning device according to claim 4, wherein the attachment surface is a curved surface.

6. An optical scanning device according to claim 5, wherein the attachment surface is substantially spherical.

7. An optical scanning device according to claim 6, wherein the body portion has a plano-spherical form.

8. An optical scanning device according to claim 1, wherein the second surface is non-planar.

9. An optical scanning device according to claim 8, wherein the second surface is substantially aspherical.

10. An optical scanning device according to claim 8, wherein the second surface includes a stepped phase structure which is non-periodic with respect to a direction perpendicular to the optical axis.

11. An optical scanning device according to claim 1, wherein the thickness variation of the wavefront aberration generating portion is such that the thickness in one part of the wavefront aberration-generating portion is at least half the thickness in another part of the wavefront aberration-generating portion.

12. An optical scanning device according to claim 1, wherein the average thickness of the wavefront aberration generating portion, taken across at least one of said first and second beams, is less than 500 μm.

13. An optical scanning device according to claim 12, wherein the average thickness of the wavefront aberration generating portion, taken across at least one of said first and second beams, is less than 100 82 m.

14. An optical scanning device according to claim 1, wherein the body portion is substantially non-birefringent.

15. An optical scanning device according to claim 14, wherein the body portion is made of a glass material.

16. An optical scanning device according to claim 1, wherein the wavefront aberration generating portion is made of a curable liquid crystal material.

17. An optical scanning device according to claim 1, wherein the optical system is arranged to operate in an infinite conjugate arrangement both when scanning using said first radiation beam and when scanning using said second radiation beam.

18. An optical element for use in an scanning device for scanning optical record carriers, the device comprising an optical system for converging first and second radiation beams onto the optical record carriers being scanned, the optical element having at least two portions arranged along an optical axis, the element including a body portion having relatively low birefringence and a wavefront aberration generating portion having a relatively high birefringence, the body portion having an attachment surface on which the wavefront aberration generating portion is formed, the wavefront aberration generating portion having a first surface facing said attachment surface and a second surface facing away from said attachment surface, the first and second surfaces being of a different shape so that the thickness of the wavefront aberration generating portion, measured parallel to said optical axis, varies along a direction perpendicular to the optical axis, and wherein the thickness of the wavefront aberration generating portion at said optical axis is less than half the thickness of the body portion along said optical axis.

19. An optical element according to claim 18, wherein the thickness of the wavefront aberration generating portion along said optical axis is less than one fifth of the thickness of the body portion along said optical axis.

20. An optical element according to claim 18, wherein the body portion is a lens body.

21. An optical element according to claim 18, wherein the second surface is non-planar.

22. An optical element according to claim 21, wherein the second surface is substantially aspherical.

23. An optical element according to claim 18, wherein the average thickness of the wavefront aberration generating portion across its width is less than 100 μm.

24. An optical element according to claim 18, wherein the body portion is substantially non-birefringent.

25. An optical element according to claim 24, wherein the body portion is made of a glass material.

26. An optical element according to claim 18, wherein the wavefront aberration generating portion is made of a curable liquid crystal material.
